(19) United States
(12) Patent Application Publication
(10) Pub. No.: US 2012/0141242 A1
(43) Pub. Date: Jun. 7, 2012

(54) ARM FOR A FORKLIFT FORK AND A FORKLIFT FORK

(75) Inventor: Olavi Savolainen, Tampere (FI)

(73) Assignee: EFFCOM OY, Kangasala (FI)

(21) Appl. No.: 13/389,999

(22) PCT Filed: Aug. 13, 2010
(86) PCT No.: PCT/FI10/50629

§ 371 Date: Feb. 10, 2012

(30) Foreign Application Priority Data
Aug. 13, 2009 (FI) 20095842

(51) Int. Cl. B66F 9/12

(52) U.S. Cl. 414/664

(57) ABSTRACT

An arm of a forklift fork including a substantially horizontal arm having a supporting surface for supporting and carrying a load. The arm may include a carriage that also includes a supporting surface for supporting and carrying a load, wherein the carriage is arranged to move in parallel to the arm in relation to the supporting surface of the arm. The carriage may include a caterpillar track for moving. The arm may include two adjacent arm parts fastened to each other, between which parts the carriage is located. The arm may include several separate units, each containing members which make the load capable of rolling in parallel to the arm. Each unit is also arranged to remain in its place.

The invention relates to an arm of a forklift fork. The invention also relates to a forklift fork.

According to prior art, various forklifts and reach trucks are used for the unloading and loading of freight containers with various loads, including various units assembled on pallets, individual products, such as paper rolls of various types and various bound stacks such as stacks of timber. In reach trucks forklift forks are used as an implement for moving and carrying loads. Forklift forks typically comprise two horizontal arms located underneath the load.

For example stacks of timber are long and when they are loaded in a freight container, the forks must be pushed underneath the stack from the end of the stack. Efficient handling of the stacks requires that the stacks are positioned on top of the fork in a stable manner. There are often transverse props or supports underneath the stacks, and the fork must be pushed under them, which makes the handling difficult because the stacks are not handled from their sides, in which case it would be easy to push the forks under the stack between the supports. The pushing of the fork under the stack may damage the supports, the load or the belts holding the stack together, or the products in the stack, especially in cases where there are no supports and the stack is heavy and long.

It is an aim of the invention to eliminate the problems presented above, relating to the handling of loads. By means of the solution according to the invention it is possible to handle loads, especially stacks of timber without damaging them.

The arm of a forklift fork according to the invention is presented in claim 1. The forklift fork according to the invention is also presented in claim 8. The arm of a forklift fork according to the invention is also presented in claim 11.

The solution also has several other advantages. By means of the solution it is possible to avoid abrasion between the load and the arms of the forklift fork, wherein it is easier to transfer the load on top of the forklift fork because there is less friction. At the same time it is possible to avoid abrasion that may damage the load.

By means of the solution the load rolls along the arm of the forklift fork, but the solution is still simple, because it is not necessary to provide the load with rolls or fasten an idler assembly to the fork on top of which the load would move. The carriage according to the solution provides the load with a supporting point which moves with the load and easily along the arm of the forklift fork. The carriage does not move in relation to the load, wherein it is not necessary to construct the lower surface of the load in such a manner that the load would slide or move easily for example on top of an idler assembly. The arm of the forklift fork is designed in such a manner that the carriage moves easily for example along a flat surface.

The solution is also simple in that respect that only a carriage which is significantly shorter than the arm and provides a supporting point for the load is required for the arm of the forklift fork. The carriage moves with respect to the arm of the forklift fork, wherein the supporting point of the load moves in relation to the arm of the forklift fork and the load can be moved on top of the arm or off the same. The forklift fork may comprise one or several arms. The carriages of two or several arms of the forklift fork can be connected with a bridge or an interconnector on top of which the load rests. By means of the bridge or the interconnector the movement of the carriages is synchronized and the load can be supported better by the forklift fork.

The solution is suitable to be used in forklift trucks or reach trucks and in various independently moving transport and lifting devices, for example in front loaders.

In another example of the solution there is a group of units in the arm of the forklift fork, on top of which units the load can roll. The units are stationary and they contain for example a caterpillar track that supports the load and by means of which it is easy to push the arm of the forklift fork underneath the load or pull the arm from underneath the load. Preferably, the units are similar to each other and they are fastened or coupled in their places in the arm of the forklift fork. It is possible to vary the number of the units in accordance with the purpose of use and on the basis of the size of the arm.

In an embodiment of the solution said unit and said carriage are the same product, but in the arm there is either one moving unit or several stationary units. The mounting position of the product varies in different embodiments, in other words, it is turned around or upside down, depending on that whether the aim is to make the load move in relation to said product (the unit described above that does not move in relation to the arm) or not (the carriage described above that moves in relation to the arm). The product moves along with the load or carries the load by means of members located therein.

The structure of the arm of the forklift fork may also be different in the embodiments described above.

In the following, the solutions according to the invention will be described in more detail with reference to the appended drawings, in which:

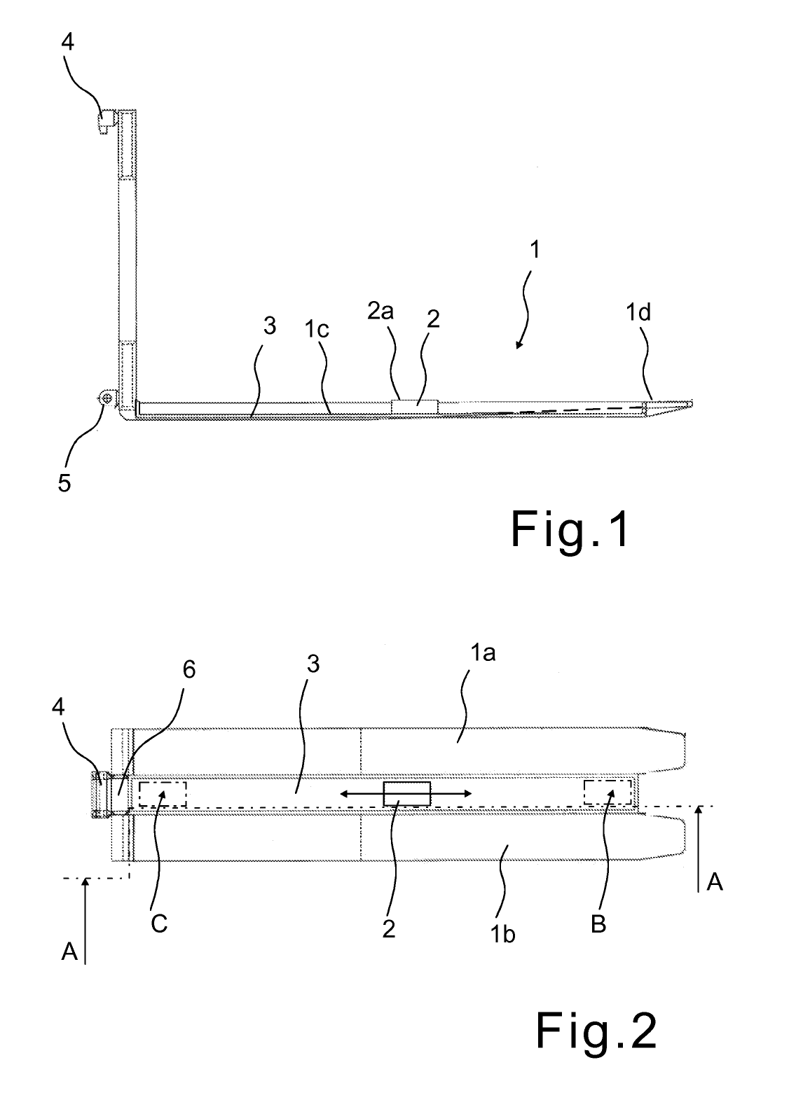

FIG. 1 shows the arm of a forklift fork according to one solution, seen from the side and cut along the line A-A of FIG. 2,

FIG. 2 shows the arm of a forklift fork according to FIG. 1 in a top view,

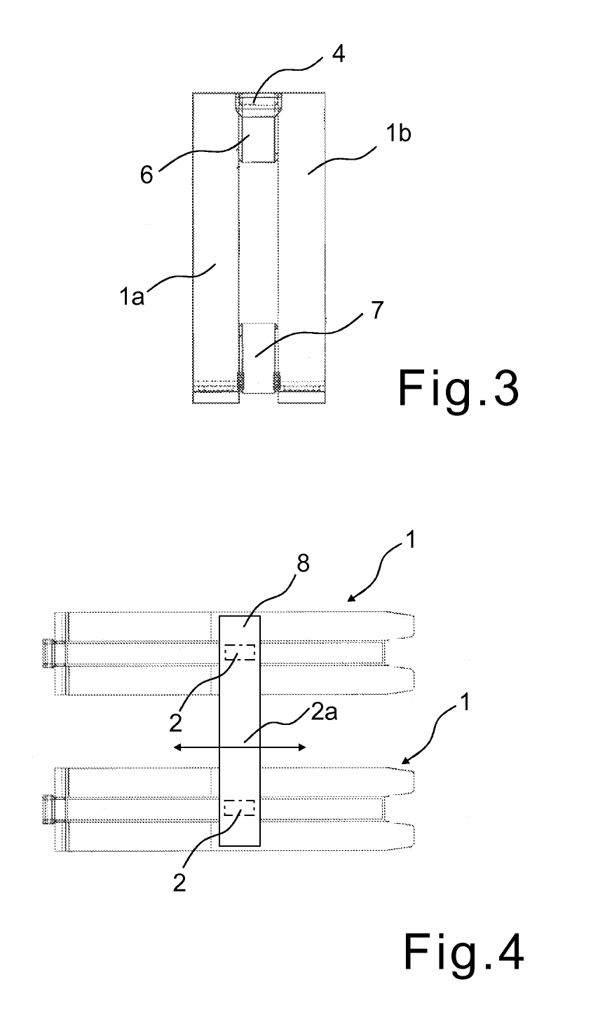

FIG. 3 shows the arm of a forklift fork according to FIG. 1 in a rear view,

FIG. 4 shows a top view of a forklift fork according to one solution in which two arms of a forklift fork according to FIG. 1 are implemented,

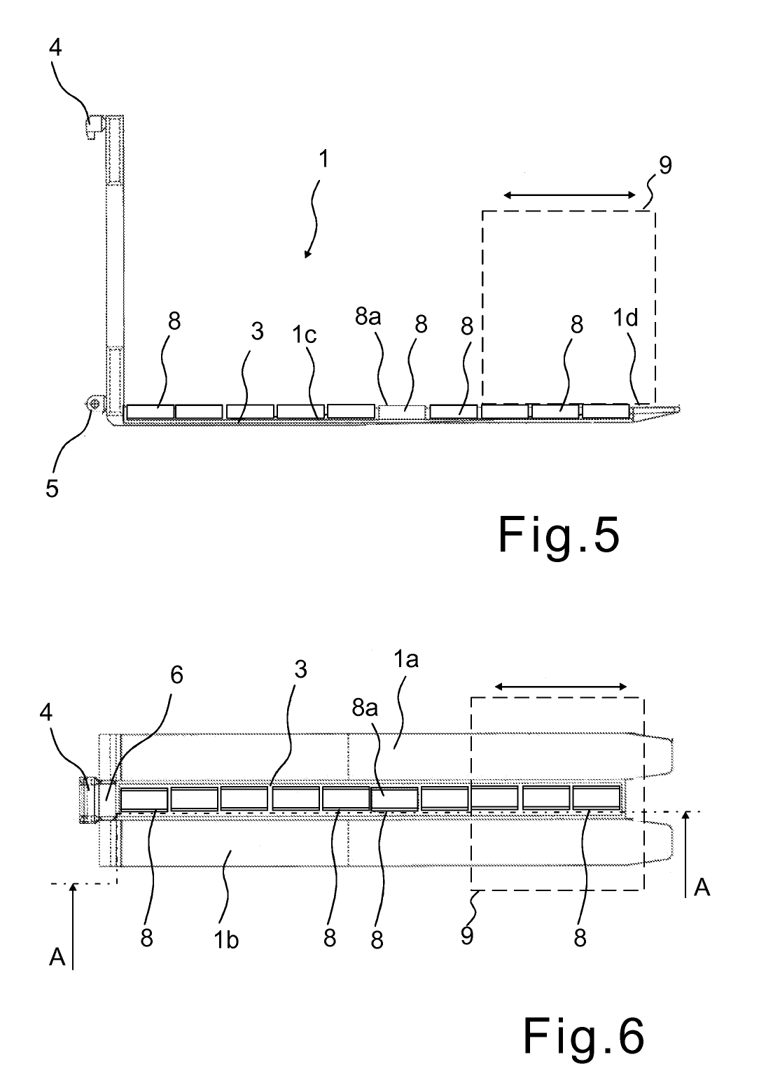

FIG. 5 shows the arm of a forklift fork according a second solution, seen from the side and cut along the line A-A of FIG. 6, and

FIG. 6 shows the arm of a forklift fork according to FIG. 5 in a top view.

Reach trucks typically comprise a boom at the end of which the arm 1 of a forklift fork shown in FIG. 1 can be fastened. At the end of the boom there is for example a transfer carriage on which the arm is suspended and fastened with fastening means. The fastening means consist for example of a claw 4 positioned at the upper end of the vertical part of the arm 1, and a fastener 5 positioned at the lower end of the vertical part of the arm.

There are typically two transfer carriages, wherein a forklift fork with two arms is formed, and the transfer carriages can be typically moved as well, wherein the mutual distance of the arms can be changed for various loads. Instead of a transfer carriage, the boom may comprise a frame for the forklift fork or members to which one or several arms are fastened with said fastening means, and the arms cannot be moved.

The arm 1 is typically L-shaped, and the load is positioned on its elongated horizontal part. The load is also positioned against the vertical part, which can be provided with a rubber coating, which because of the friction between the load and the rubber keeps especially a long stack of timber in its place and prevents it from swinging forward, away from the fork. In this specification reference is made to the operating position of the arm, in which it is substantially horizontal.

In accordance with the solution of FIG. 2, the horizontal part of the arm 1 is provided with a moving carriage 2, capable of moving back and forth in the longitudinal direction of the arm 1. The upper surface of the carriage 2 is provided with a supporting surface positioned under the load and supporting the load.

In the solution according to FIG. 2, the carriage 2 is of such a type that there are members on the lower surface of the carriage by means of which the carriage 2 is capable to move in a rolling manner along the supporting surface in the arm 1. Said supporting surface is in the example of FIG. 2 positioned in a longitudinal trough 3, along which the carriage moves and for example the edges of the trough 3 restrict the movement of the carriage 2 both in the longitudinal and transverse direction. The carriage 2 can also be arranged to move along the arm 1 in other ways, taking advantage of various idler assemblies, rolls or guides. However, in this example a simple and reliable structure has been attained, because the carriage 2 contains members for rolling and only a supporting surface for the carriage 2 is necessary in the arm 1. Preferably said members comprise a caterpillar track constructed advantageously of a chain, or for example a belt. The endless belt or chain travels around idler wheels.

Preferably, the carriage 2 is fastened to the arm 1 in a removable manner. Preferably, when the arm 1 does not contain a carriage 2 it can also be used as a conventional arm of a forklift fork. The supporting surface of the arm 1 along which the carriage 2 moves is preferably separate with respect to the supporting surface of the arm 1 against which the load is positioned. In use, the supporting surface 1c of the arm intended for the carriage 2 is in the example of FIG. 2 located on a lower level than the supporting surface 1d of the arm intended for the load. The supporting surface 2a of the carriage that is intended for the load is, in turn, positioned on a higher level than the supporting surface 1d of the arm. The supporting surfaces are positioned in the manner described above in all positions of the carriage 2 between the end positions B and C of the carriage 2 shown in FIG. 2, and in said end positions.

The forklift fork is used in such a manner that the carriage 2 is located for example at the outermost end of the arm 1, for example in the end position B and the carriage 2 is positioned underneath the load, for example under the end of a stack of timber. The load is raised by means of the carriage 2 and at the same time the arm 1 is tilted forward so that the arm 1 can be pushed further underneath the load. Because the load then remains in its place, the carriage 2 between the arm 1 and the load also remains in its place, but the arm 1 moves in relation to the carriage 2. The forklift fork is moved until the load is sufficiently on top of the arm, wherein the carriage 2 is positioned for example in the end position C and the load is positioned against the vertical part of the arm 1. Thereafter the arm 1 is tilted backward, so that the outermost end of the arm 1 is also positioned against the load underneath the load, holding the load in its place. Thus, the carriage 2 and the load are not capable of moving, because the other parts of the arm hold the load in its place by means of friction and support the load together with the carriage 2. The delivery of the load takes place in opposite order when compared to the aforementioned method.

FIGS. 1 to 3 also show an example of the solution, which utilizes traditional arms of forklift forks. According to FIG. 2, the arm 1 comprises two conventional arms of a forklift fork, which form the arm parts 1a and 1b located next to each other, between which the trough 3 and the fastening means 4 and 5 have been mounted. The arm parts 1a, 1b are also fastened to each other for example by means of bridges or connecting beams 6 and 7, which are located for example in the vertical part. The length of the trough 3 nearly corresponds to the length of the arm parts 1a, 1b and the horizontal part of the arm 1.

In accordance with FIG. 4, the forklift fork can be formed of two arms 1 of the forklift fork according to the solution, the carriages 2 of which have been connected by means of a bridge 8. The bridge 8 synchronizes the movements of the carriages 2 and it makes it possible to form a wider supporting surface 2a for the load. The carriages 2 may also be connected with a bridge that is not supported underneath the load. In the example of FIG. 4, the bridge 8 is positioned on top of the carriages 2, and it is fastened to the carriages 2 in a removable manner. There may be several bridges 8 in use, and each of them is being used for a specific distance between the arms 1. Alternatively, the bridge 8 and at least one carriage 2 are connected to each other so that the carriage 2 is capable of moving in parallel to the bridge 8 when the distance between the arms 1 is changed for example by means of the transfer carriages of the forklift fork, or the distance between the arms 1 is changed manually.

The members by means of which the carriage 2 is capable of rolling along the supporting surface on the arm 1 can also be integrated to the bridge 8, wherein the bridge 8 at the same time forms the necessary carriage and the structure connecting the arms 1, providing a combined supporting surface or several supporting surfaces for the load, corresponding to one or several supporting surfaces 2a. Said carriage and bridge structure is thus supported by two or several adjacent arms.

FIG. 5 shows another solution for the arm 1 of the forklift fork. In accordance with the solution of FIG. 5, the horizontal part of the arm 1 is provided with successive units 8 for supporting the load 9. Each unit 8 is separate and remains in its place during use. The load 9 is capable of moving back and forth in the longitudinal direction of the arm 1 on top of the units 8. The upper surface of the unit 8 is provided with a supporting surface 8a positioned under the load and supporting the load.

In the solution according to FIG. 5, each unit 8 is of such a type that there are members on the upper surface 8a of the unit by means of which the load 9 is capable of rolling along the arm 1 and against the unit 8. Said unit 8 is in the example of FIG. 5 positioned in a longitudinal trough 3, and for example the edges of the trough 3 keep the units 8 in their places both in the longitudinal and transverse direction. The units 8 can be fastened to the arm 1 in other ways as well. The trough 3 may be replaced with a supporting surface of corresponding size, for example a planar plate. The load 9 can also be arranged to move along the unit 8 in other ways, taking advantage of various idler assemblies, rolls or guides. However, in this example a simple and reliable structure has been attained, because the unit 8 contains members for rolling and only a supporting surface suitable for the units 8 is necessary in the arm 1. Preferably said members comprise a caterpillar track constructed advantageously of a chain, or for example a belt. The endless belt or chain travels around idler wheels. In one example the caterpillar track is composed of successive rolls connected to each other and forming an endless loop. The caterpillar track rolls around the unit 8 so that in the supporting surface 8a the load 9 is supported by the caterpillar track, which, in turn is supported by the frame of the unit, and the rolling rolls move the load 9 at the same time. In the lower surface of the unit 8 the frame of the unit is supported by the arm, for example the supporting surface of the arm. The caterpillar track moves past the frame and through the same so that the caterpillar track is not supported by the arm 1, wherein the unit 8 remains in its place.

Preferably, the unit 8 is fastened to the arm 1 in a removable manner. Preferably, when the arm 1 does not contain units 8 it can also be used as a conventional arm of a forklift fork. The supporting surface of the arm 1 to which the units 8 are to be fastened can be separate with respect to the supporting surface of the arm 1 against which the load is positioned. In use, the supporting surface 1c of the arm intended for the units 8 is in the example of FIG. 5 located on a lower level than the supporting surface 1d of the arm intended for the load. The supporting surface 8a of the unit 8 intended for the load is, in turn, positioned on a higher level than the supporting surface 1d of the arm.

The forklift fork is used in such a manner that the unit 8 is positioned under the load. The load is raised by means of the unit 8 and at the same time the arm 1 is tilted forward so that the arm 1 can be pushed further underneath the load and the unit 8 rolls against the load together with the arm 1. The forklift fork is moved until the load is sufficiently on top of the arm. Thereafter the arm 1 is tilted backwards. There are situations in which the outermost end of the arm 1 that does not contain a unit 8 is positioned against the load underneath the load, holding it in its place. The delivery of the load takes place in opposite order when compared to the aforementioned method.

FIGS. 5 and 6 also show an example of the solution, which utilizes traditional arms of forklift forks. According to FIG. 5, the arm 1 comprises two conventional arms of a forklift fork, which form the arm parts 1a and 1b located next to each other, between which the groove 3 or the supporting surface of said units and the fastening means 4 and 5 have been mounted. The arm parts 1a, 1b are also fastened to each other for example by means of bridges or connecting beams 6 and 7, which are located for example in the vertical part. The length of the trough 3 or the supporting surface nearly corresponds to the length of the arm parts 1a and 1b and the horizontal part of the arm 1.

The invention is not limited solely to the examples discussed or presented above, but it may vary according to the appended claims.

1. An arm of a forklift fork, comprising:
a substantially horizontal arm comprising a supporting surface for supporting and carrying a load, wherein the arm further comprises a carriage which also comprises a supporting surface for supporting and carrying a load, wherein said carriage is arranged to move in parallel to the arm in relation to the supporting surface of the arm.

2. The arm of a forklift fork according to claim 1, wherein the supporting surface of the arm is located on a lower level than the supporting surface of the carriage.

3. The arm of a forklift fork according to claim 1, further comprising:
a supporting surface for the carriage, wherein said carriage is arranged to move along said supporting surface.

4. The arm of a forklift fork according to claim 1, wherein the carriage further comprises a caterpillar track for moving.

5. The arm of a forklift fork according to claim 1, further comprising:
a trough along which said carriage is arranged to move.

6. The arm of a forklift fork according to claim 1, wherein the arm further comprises a horizontal part and a substantially vertical part fastened thereto, the substantially vertical part comprising a fastener configured to fasten to a forklift truck or a reach truck.

7. The arm of a forklift fork according to claim 1, wherein the arm further comprises two adjacent arm parts fastened to each other, between which parts said carriage is located.

8. A forklift fork, comprising:
two substantially horizontal arms each comprising a supporting surface for supporting and carrying a load, wherein each arm further comprises a carriage which also contains a supporting surface for supporting and carrying a load, wherein said carriage is arranged to move in parallel to the arm in relation to the supporting surface of the arm.

9. The forklift fork according to claim 8, wherein two or several of said carriages are connected by a bridge which synchronizes movement of the carriages and in which the supporting surface of the carriage is located.

10. The forklift fork according to claim 9, wherein at least one of said carriages is connected to the bridge in such a manner that a location of the carriage in relation to the bridge can be transferred in parallel to the bridge, transversely with respect to the arm, wherein the distance between the arms can be changed.

11. An arm of a forklift fork, comprising:
a substantially horizontal arm intended for supporting and carrying a load, wherein the arm comprises a number of separate successive units each comprising a supporting surface for supporting and carrying a load, and members on the supporting surface which make the load capable of rolling in parallel to the arm wherein said unit is also arranged to remain in its place.

12. The arm of a forklift fork according to claim 11, wherein the arm further comprises a supporting surface for supporting and carrying the load, wherein the supporting surface of the arm is located on a lower level than the supporting surfaces of the units.

13. The arm of a forklift fork according to claim 11, further comprising:
a supporting surface for the units, wherein said supporting surface is arranged to carry several units and to hold them in their places.

14. The arm of a forklift fork according to claim 11, wherein each unit comprises a caterpillar track for moving the load.

15. The arm of a forklift fork according to claim 11, wherein the arm further comprises a trough in which said units are placed.

16. The arm of a forklift fork according to claim 11, wherein the arm further comprises a horizontal part and a substantially vertical part fastened thereto, wherein the substantially vertical part comprises a fastener configured to fasten to a forklift truck or a reach truck.

17. The arm of a forklift fork according to claim 11, wherein the arm comprises two adjacent arm parts fastened to each other, between which parts said units are located.

18. The arm of a forklift fork according to claim 11, wherein said unit which is turned upside down, forms a carriage comprising a supporting surface for supporting and carrying the load, wherein said carriage is arranged to move in parallel to the arm.

19. The arm of a forklift fork according to claim 18, further comprising:
a supporting surface for the units, wherein said supporting surface is arranged to carry several units and to hold them in their places, and said carriage is arranged to move along said supporting surface.

20. The arm of a forklift fork according to claim 18, wherein each unit comprises a caterpillar track.
